(19) United States
(12) Patent Application Publication
(10) Pub. No.: US 2009/0295277 A1
(43) Pub. Date: Dec. 3, 2009

(54) Glass packages and methods of controlling laser beam characteristics for sealing them

(76) Inventors: Stephan Lvovich Logunov, Corning, NY (US); John David Lorey, Corning, NY (US); Vitor Marino Schneider, Painted Post, NY (US)

Correspondence Address: CORNING INCORPORATED, SP-TI-3-1, CORNING, NY, 14831, US

(21) Appl. No.: 12/154,878

(22) Filed: May 28, 2008

(51) Int. Cl. H01J 9/26; H01J 1/62; H01T 21/06

(52) U.S. Cl. 313/504; 445/25; 445/3

(57) ABSTRACT

A display device (10) including a first substrate (12), a second substrate (16), an OLED element (18), and a wall (14) that contains glass. A sealed portion (6) is formed in the wall and between the first substrate and the second substrate so as to produce a hermetic seal. The sealed portion is disposed in the wall so that unsealed portions (7,8) are disposed on opposite sides of the sealed portion. A width (3) of the sealed portion is from about 35% to about 77.3% of a width (2) of the wall. The sealed portion may be formed by heating the wall with a laser beam (32) so that a thickness (1) of the wall lies within the depth of focus (34) of the laser beam. Further, the width (36) of the laser beam can be less than or equal to the width of the wall.

### BACKGROUND

### Field of the Invention

This invention is generally directed to methods for sealing glass packages for encapsulating a display element such as used for glass substrates for flat panel display devices, for example, organic light emitting diode (OLED) display devices. Also disclosed are glass packages formed according to aspects of the disclosed methods.

### TECHNICAL BACKGROUND

Laser heating of a wall, disposed between a first substrate and a second substrate, and formed from dispensed frit that has been sintered, to form hermetic seals for display devices has conventionally been used.

One current laser sealing method is designed so that the laser beam is defocused and its size is controlled by the distance from a laser delivery system to the display device. However, because the laser beam size is controlled by the distance between the laser delivery system and the display device, this system is sensitive to changes in this distance as produced by vibrations and imperfections in the laser delivery system, for example.

Also, some laser sealing methods required use of a laser mask. The reason for having a laser mask was to achieve the widest possible seal width and protect nearby device elements (such as thin film electronics, OLED elements or electrodes, for example) from direct laser exposure. The edges of the wall may be at a lower temperature than the center of the wall due to the energy distribution (intensity profile) in the laser beam. This temperature distribution can be improved by increasing beam diameter. In doing so, however, the device elements may be exposed to laser radiation creating heat damage.

In one sealing method that uses a mask, a mask sheet is disposed over the device substrate so as to expose the wall along its entire perimeter so that the wall may be heated with a laser. In general, the mask is of a similar size as the substrate. This masking method works effectively, but a drawback is the need to have an additional piece of glass with the mask disposed thereon, which needs to be made and aligned with the OLED substrate. In addition, using weights or an application of sealing force with a mask present reduces the effectiveness of such pressure applications.

### SUMMARY

In one embodiment, a wall is presented. The wall includes a width, a thickness, and edges. Further, the wall contains glass, and is disposed between first and second substrates. A sealed portion of the wall couples the first and second substrates to one another. The width of the sealed portion is from about 35% to about 77.3% of the width of the wall.

A laser beam is directed at the wall to form the sealed portion in the wall. The laser beam includes two specific characteristics, namely, a depth of focus and an intensity profile.

The laser beam depth of focus extends vertically over a range of the laser beam. In one embodiment, the depth of focus may be described as the portion of the laser beam that includes a substantially constant width and a consistent power density over the vertical range of the laser beam. The vertical range of the laser beam is located about a focal point of the laser beam.

An intensity profile of the laser beam is defined across the width of the laser beam. The intensity profile includes a maximum intensity portion near the center of the width of the laser beam, and lesser intensity portions outside of the maximum intensity portion. The maximum intensity portion is that portion of the laser beam that has an intensity sufficiently high enough to produce the sealed portion in the wall. The lesser intensity portions are located outside of the area defined by the maximum intensity portion. The lesser intensity portions do not have an intensity that is sufficiently high enough to produce a sealed portion in the wall. The width of the laser beam is that at which the intensity drops to less than about 2-3% of its maximum value.

In one embodiment, the intensity profile is described by a Gaussian distribution with a center area portion corresponding to the maximum intensity portion of the laser beam that is suitable for producing the sealed portion of the wall. The side lobes in the Gaussian distribution correspond to lesser intensity portions of the laser beam outside of the maximum intensity portion. The lesser intensity portions do not have an intensity sufficiently high enough to produce a sealed portion in the wall. In one embodiment, the resulting wall includes sealed and unsealed portions, wherein the sealed portion has a width that is between 35% to 77.3% of the width of the wall. The side lobes are directed toward the wall such that the radiation produced by the side lobes of the laser beam is absorbed by the unsealed portions of the wall. Thus, the unsealed portions of the wall protect the device elements (such as electrodes and OLED elements) thereby eliminating the need for a mask.

In one embodiment, the laser beam is directed toward the wall such that the entire thickness of the wall is positioned within the depth of focus of the laser beam. In a second embodiment, the laser beam is directed at the wall such that the laser beam width is less than or equal to the width of the wall. As such the maximum intensity portion will seal the center portion of the wall producing a wall with a sealed center portion that is flanked by two unsealed portions one on each side of the sealed portion. It should be appreciated that while these two embodiments directed to using a laser beam to form a sealed portion in the wall are described separately, in another embodiment, both of these embodiments may be combined.

By sealing a wall of a device with a laser beam so that the thickness of the wall lies within the depth of focus of the laser beam, uniformity of the seal is less sensitive to vibrations and imperfections in the delivery system, as well as less sensitive to changes in the distance between the delivery system and the display device.

The mask can be eliminated by sealing a wall of a device with a laser beam having a width that is less than or equal to the width of the wall, wherein the width of the laser beam corresponds to that at which the intensity drops to less than about 2-3% of its peak value. Elimination of a laser mask is advantageous from the perspectives of simplicity of the process and cost effectiveness.

Additional features and advantages of the invention will be set forth in the detailed description which follows, and in part will be readily apparent to those skilled in the art from the description or recognized by practicing the invention as described in the written description and claims hereof, as well as the appended drawings.

According to one aspect, there is provided a device including a first substrate, a second substrate, and a wall coupling the first substrate to the second substrate. The wall has a width, a thickness, a sealed portion, unsealed portions located on opposite sides of the sealed portion, and contains glass. The width of the sealed portion is from about 35% to about 77.3% of the width of the wall.

According to another aspect, the width of the sealed portion is from about 50% to about 75% of the width of the wall.

According to another aspect, the sealed portion is disposed in the wall so that the unsealed portions are substantially equal in width.

According to another aspect, there is provided a method of sealing two substrates coupled by a wall including a width, and a thickness. The method of sealing includes directing a laser beam toward the wall. The laser beam has a depth of focus and a beam width, wherein the beam width includes an intensity profile. The laser beam is positioned relative to the wall so that the wall thickness lies within the depth of focus of the laser beam.

According to another aspect, the laser beam intensity profile produces in the wall a sealed portion having a width, wherein the width of the sealed portion is from about 35% to about 77.3% of the width of the wall.

According to another aspect, the laser beam width is less than or equal to the width of the wall.

According to another aspect, the laser beam width is larger than the width of the wall, and the method further includes disposing a beam-shaping plate having an aperture therein so that the laser beam is aligned to pass through the aperture prior to reaching the wall. The aperture has a width that is less than or equal to the width of the wall.

According to another aspect, the laser beam is traversed relative to the wall, and the beam-shaping plate is traversed along with the laser beam so as to maintain alignment between the laser beam and the aperture.

According to another aspect, the beam-shaping plate is disposed within the depth of focus of the laser beam.

According to another aspect, the laser beam is a flat-top laser beam.

According to another aspect, the laser beam includes a footprint having a center-portion, wherein an area of the center-portion is less than an area on either side of the center-portion.

According to another aspect, the laser beam is directed through a delivery system. The delivery system includes a lens for focusing the laser beam, and the method further includes at least one of: measuring temperature of the wall with a thermal monitoring device via the lens; and obtaining a visual image of the wall with an imaging device via the lens.

According to another aspect, there is provided a method of sealing a two substrates coupled by a wall including a width, and a thickness. The method of sealing includes directing a laser beam toward the wall. The laser beam has a depth of focus and a beam width, wherein the beam width includes an intensity profile. The intensity profile includes a maximum intensity portion sufficient to form a sealed portion in the wall and lesser intensity portions that do not form a sealed portion in the wall. The laser beam is positioned relative to the wall so that the beam width is less than or equal to the wall width.

It is to be understood that both the foregoing general description and the following detailed description are merely exemplary of the invention, and are intended to provide an overview or framework to understanding the nature and character of the invention as it is claimed.

The accompanying drawings are included to provide a further understanding of principles of the invention, and are incorporated in and constitute a part of this specification. The drawings illustrate one or more embodiment(s), and together with the description serve to explain the principles and operation of the invention.

### BRIEF DESCRIPTION OF THE DRAWINGS

FIG. 1 is a cross sectional side view of a display device according to one embodiment.

FIG. 2 is a partial cross sectional side view of a display device and a delivery system that may be used to direct a laser beam for sealing the wall.

FIG. 3 is a partial cross sectional side view of a wall and a laser beam used to seal the wall.

FIG. 4 is a top view of the wall and laser beam of FIG. 3.

FIG. 5 is a schematic diagram of a lens and laser beam focused by the lens.

FIG. 6 is a graph showing laser beam width at various distances from the focal point of the lens.

FIG. 7 is a graph of laser beam intensity at various distances across the width of a wall, for a Gaussian beam, and showing seal width in relation to the width of the wall according to one example.

FIG. 8 is a graph of laser beam intensity at various distances across the width of a wall, for a flat-top beam, and showing seal width in relation to the width of the wall, according to another example.

FIG. 9 is a graph of laser beam intensity at various distances across the width of a wall, for a flat-top beam, and showing seal width in relation to the width of the wall, according to another example.

FIG. 10 is a graph showing the probability of failure at various 4-point fracture loads for devices sealed with laser beams having different characteristics.

FIG. 11 is a schematic view of a circular laser beam footprint.

FIG. 12 is a schematic view of a square laser beam footprint.

FIG. 13 is a schematic view of a cross-shaped laser beam footprint.

FIG. 14 is a schematic view of a square-in-square laser beam footprint.

FIG. 15 is a partial cross sectional side view of a display device and a delivery system having a beam-shaping plate during a sealing operation.

FIG. 16 is a schematic top view of a beam-shaping plate having an aperture.

### DETAILED DESCRIPTION

In the following detailed description, for purposes of explanation and not limitation, example embodiments disclosing specific details are set forth to provide a thorough understanding of the principles of the present invention. However, it will be apparent to one having ordinary skill in the art, having had the benefit of the present disclosure, that the present invention may be practiced in other embodiments that depart from the specific details disclosed herein. Moreover, descriptions of well-known devices, methods and materials may be omitted so as not to obscure the description of the principles of the present invention. Finally, wherever applicable, like reference numerals refer to like elements.

Although the sealing techniques of the present invention are described with respect to manufacturing a hermetically sealed display device having an OLED element, it should be understood that the same or similar sealing techniques can be used to seal two glass plates to one another that can be used in a wide variety of applications and devices. Accordingly, the sealing techniques of the present invention should not be construed in a limited manner.

The sealing techniques disclosed herein generally involve controlling the characteristics of a laser beam, used to seal a wall in a display device.

In one sealing technique, a focused laser beam is used to seal the display device by heating the wall with the laser so that the wall thickness is within the depth of focus of the laser beam. A focused laser beam may have a depth of focus that allows better tolerances for alignment of the delivery system with respect to the display device and, therefore, is more immune to changes in distance between the delivery system and the display device such as due to vibrations and imperfections of the delivery system, for example. In addition, operating within the depth of focus of the laser beam is advantageous in that it is possible also to provide an imaging device operating through the same delivery system as for the laser beam and to provide a thermal monitoring device for measuring the temperature of the sealing process, also operating through the same delivery system as for the laser beam.

A second technique involves controlling the width and intensity profile of the laser beam so that the width, at which the laser beam intensity drops to less than about 2-3% of its maximum, is less than the width of the wall. With this technique, a mask can advantageously be eliminated.

In either technique, different laser beam footprint shapes can be used to minimize the damage to the device elements while keeping a good sealing strength and high hermeticity of the display devices.

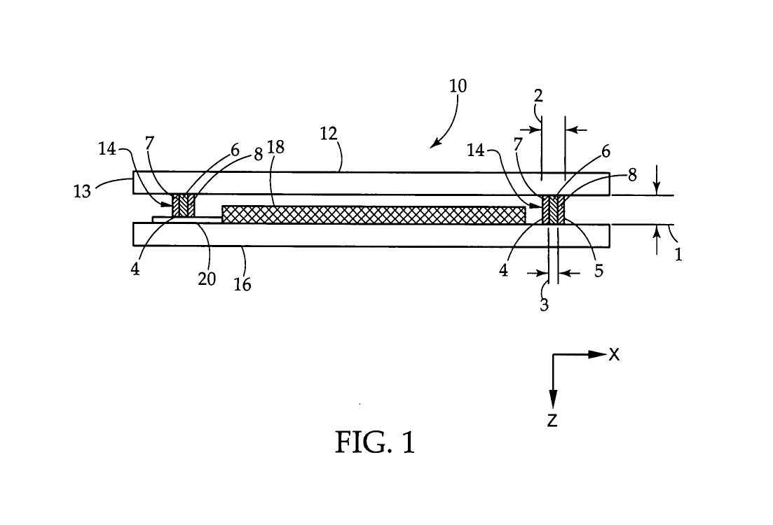

FIG. 1 is a partial cross sectional side view of a hermetically sealed organic light emitting diode (OLED) display device 10 in accordance with an embodiment of the present invention. The display device 10 generally comprises a first substrate 12, a wall 14, a second substrate 16, at least one OLED element 18 and at least one electrode 20 in electrical contact with the OLED element 18.

The first substrate 12 may be a transparent glass plate like the ones manufactured and sold by Corning Incorporated under the brand names of Code 1737 glass or Eagle 2000™ glass. Alternatively, first substrate 12 can be any transparent glass plate such as, for example, the ones manufactured and sold by Asahi Glass Co. (e.g., OA10 glass and OA21 glass), Nippon Electric Glass Co., NHTechno and Samsung Corning Precision Glass Co. Second substrate 16 may be the same glass substrate as first substrate 12, or second substrate 16 may be a non-transparent substrate.

Typically, OLED element 18 is in electrical contact with an anode electrode and a cathode electrode. As used herein, electrode 20 in FIG. 1 represents either electrode. Although only a single OLED element is shown for simplicity, display device 10 may have many OLED elements disposed therein. The typical OLED element 18 includes one or more organic layers (not shown) and anode/cathode electrodes. However, it should be readily appreciated by those skilled in the art that any known OLED element 18 or future OLED element 18 can be used in display device 10. In addition, it should be appreciated that another type of thin film device can be deposited besides OLED element 18. For example, thin film sensors may be fabricated using the principles present invention.

The wall 14 contains glass, has a thickness 1, a width 2, edges 4, 5 and is disposed between the first substrate 12 and second substrate 16. See FIG. 1. Additionally, the wall 14 includes a sealed portion 6 that is connected to first substrate 12 and to second substrate 16 so as to form a hermetically sealed space in which the OLED element 18 is disposed. The sealed portion 6 has a seal width 3. On either side of the sealed portion 6, there are unsealed portions 7 and 8 which may be sintered but do not form a hermetic seal between the first 12 and second 16 substrates. Although the wall 14 is shown as being rectangular in cross-section, such is for the sake of simplicity alone. The cross-sectional shape of the wall is not particularly limited. The wall can be any deployment of material containing glass, and can have any suitable cross-sectional shape so as to adequately position the first substrate 12 relative to the second substrate 16.

Prior to sealing first substrate 12 to second substrate 16, i.e., forming sealed portion 6, frit is deposited to form a wall 14 on first substrate 12, typically as a line of a frit paste comprising a glass powder, a binder (usually organic) and/or a liquid vehicle. The wall 14 is then heated to sinter the frit, after which the second substrate 16 (including OLED element 18 and electrodes 20) is placed on the wall 14 so as to sandwich the wall 14 between the first 12 and second 16 substrates. Subsequently, a laser beam 32 is directed toward the wall 14 to form sealed portion 6.

Frit can be deposited onto first substrate 12 by screen-printing or by a programmable auger robot which provides a well-shaped pattern—to form wall 14—on first substrate 12. For example, frit can be formed into a wall 14 approximately 1 mm away from the free edges 13 of first substrate 12 as a line, or a plurality of connected lines, and is typically deposited in the shape of a closed frame. Again, the cross-sectional shape of the wall is not particularly limited. The frit may be, for example, a low temperature glass frit that has a substantial optical absorption cross-section at a predetermined wavelength which matches or substantially matches the operating wavelength of the laser used in the sealing process. The frit may, for example, contain one or more light absorbing ions chosen from the group including iron, copper, vanadium, neodymium and combinations thereof (for example). The frit may also include a filler (e.g., an inversion filler or an additive filler) which changes the coefficient of thermal expansion of the frit so that it matches or substantially matches the coefficient of thermal expansions of substrates 12 and 16. For a more detailed description regarding exemplary frit compositions that may be used in this application, reference is made to U.S. Pat. No. 6,998,776 entitled “Glass Package that is Hermetically Sealed with a Frit and Method of Fabrication”, the contents of which are incorporated by reference herein.

The wall 14 may be sintered prior to sealing first substrate 12 to second substrate 16. To accomplish this, the frit deposited to form the wall 14 on first substrate 12 is heated so that the wall 14 becomes attached to first substrate 12. Then, first substrate 12 with wall 14 attached thereto can be placed in a furnace which “fires” or consolidates the frit of the wall 14 at a temperature that depends on the composition of the frit. During the sintering phase, the frit of the wall 14 is heated and organic binder materials contained within the frit are burned out.

The thickness 1 of the wall 14 is on the order of hundreds of microns, depending on the application for display device 10. An adequate but not overly thick wall allows the substrates to be sealed from the backside of first substrate 12. If the wall 14 is too thin it does not leave enough material to absorb the laser radiation. If the wall 14 is too thick it will be able to absorb enough energy at the first surface to melt, but will prevent the necessary energy needed to melt the material of the wall 14 from reaching the region of the wall proximate second substrate 16.

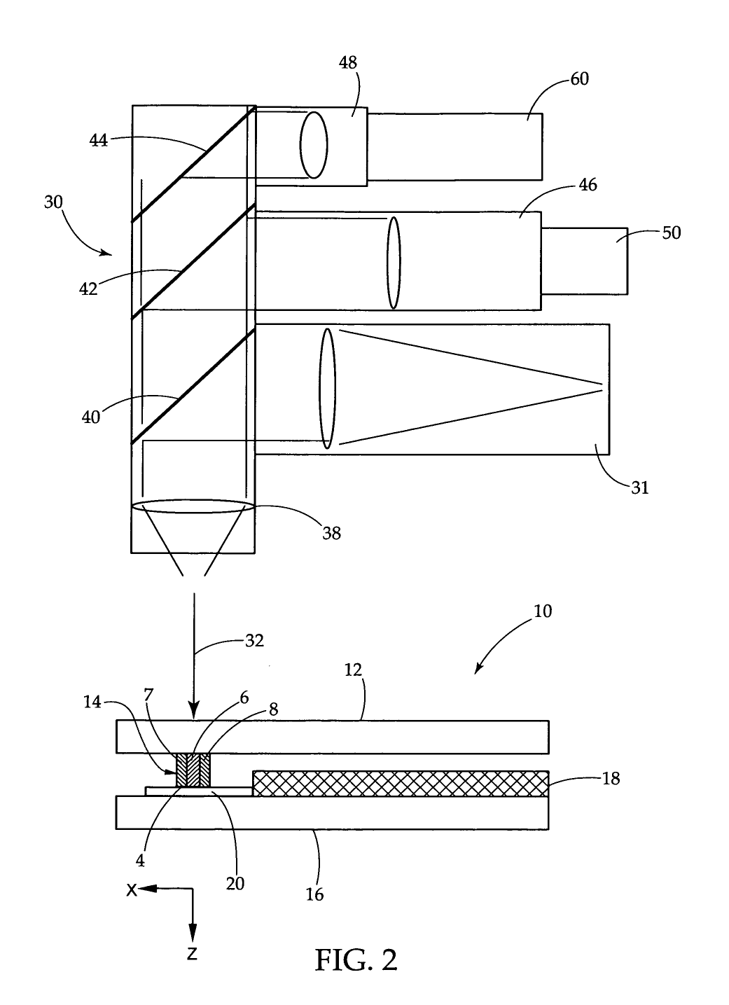

The sealing process includes placing first substrate 12, with wall 14, on top of second substrate 16, with one or more OLED elements 18 and one or more electrodes 20 deposited on the second substrate 16, in such a manner that wall 14, the one or more OLED elements 18, and electrodes 20 are sandwiched between the two substrates 12 and 16 separated by wall 14. Mild pressure can be applied to substrates 12 and 16 to keep them in contact during the sealing process. A laser beam 32 is directed onto wall 14 through first substrate 12 and heats the wall 14 such that the wall 14 at least partially melts and forms sealed portion 6 that forms a hermetic seal connecting and bonding substrate 12 to substrate 16. The hermetic seal also protects OLED elements 18 by preventing oxygen and moisture in the ambient environment from entering into display device 10. A delivery system 30, as shown in FIG. 2 for example, may be used to direct the laser beam 32 onto the wall 14.

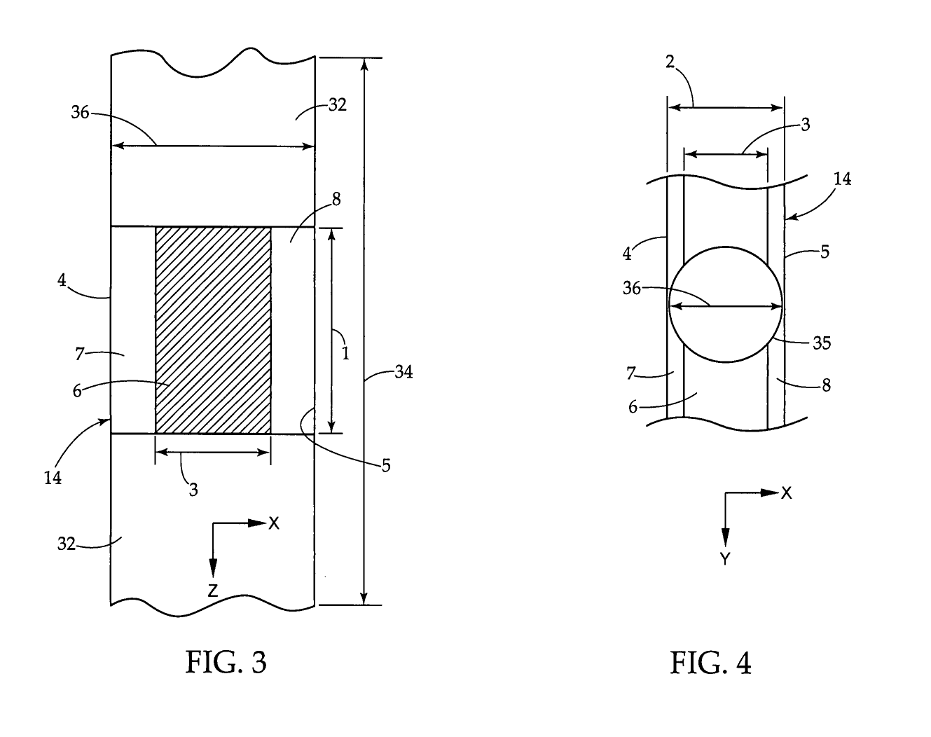

For one exemplary embodiment, the laser beam 32 is shown in relation to the wall 14 in FIGS. 3 and 4. FIG. 3 is a cross-sectional view of the wall 14 as situated similarly to the wall 14 shown on the right side of FIG. 1 but having a laser beam 32 superimposed thereon. FIG. 4 is a top view of the wall 14, having a laser beam footprint 35 superimposed thereon. The first substrate 12 and second substrate 16 are not shown in FIG. 3 for sake of simplicity, but would be located on the top and bottom of the wall 14 as those directions are shown in FIG. 3. As seen in FIG. 3, the thickness 1 of the wall 14 lies within the depth of focus 34 of the laser beam 32. As seen in FIG. 4, the laser beam 32 has a footprint 35 having a width 36 shown across the top of the wall 14. It should be noted that the width 36 is the width of the laser beam 32 at the point wherein the intensity drops to less than about 2-3% of its peak value. The intensity of less than about 2-3% of the maximum intensity is a value that is not expected to create any damage to the OLED elements 18 in the display device 10. As shown in FIGS. 3 and 4, the width 36 of the laser beam 32 is equal to the width 2 of the wall 14, but the width 36 may be less than the width 2. Because the width 36 of the laser beam 32 is that at which the intensity drops to less than about 2-3% of its peak value, the laser beam width includes a maximum intensity portion sufficient to form a sealed portion 6 in the wall 14 and lesser intensity portions that do not form a sealed portion 6 in the wall 14. Accordingly, the width 3 of the sealed portion 6 produced by the laser beam 32 is less than the width 36 of the laser beam 32, and is less than the width 2 of the wall 14. Accordingly, unsealed portions 7 and 8 are disposed on either side of the sealed portion 6, as shown in FIGS. 3 and 4.

Laser beam 32 is traversed relative to the display device 10 so as to follow the path of the wall 14. Relative motion between display device 10 and the laser beam 32 may be accomplished by moving display device 10 relative to the laser beam 32, or moving the laser 31 (and therefore the laser beam 32), relative to the display device 10. For example, the laser 31, or the display device 10, may be mounted to a stage movable in an x-y plane. The stage can be, for example, a linear motor stage whose movement may be computer controlled. Alternatively, both the display device 10 and the laser 31 may be stationary, and the laser beam 32 moved relative to the display device 10 by directing laser beam 32 from the laser 31 to one or more movable reflectors (mirrors) controlled (moved) by galvometers. The speed of travel of the laser 31 (or laser beam 32) relative to the wall 14 can range from between about 0.5 mm/s to as much as 300 mm/s, although a speed of between 30 mm/s and 40 mm/s is more typical. The power necessary from the laser beam 32 may vary depending on the optical absorption coefficient α and thickness 1 of wall 14. The necessary power is also affected if a reflective or absorbent layer is placed beneath wall 14 (between wall 14 and substrate 16) such as materials used to fabricate electrode(s) 20, and by the speed of traverse of laser beam 32 relative to the wall 14.

Additionally, the composition, homogeneity and filler particle size of the frit used to make wall 14 can vary. This, too, can adversely affect the way the wall absorbs the optical energy of laser beam 32. As laser beam 32 is traversed to follow the path of the wall 14, a portion of the wall 14 melts to form sealed portion 6 that forms a hermetic seal in the wall 14 and between the substrates 12 and 16 thus sealing the substrates one to the other. The gap between substrates 12 and 16 caused by the sealed portion 6 forms a hermetic pocket or envelope for OLED element 18. It should be noted that if second substrate 16 is transparent at the sealing wavelength, sealing may be performed through second substrate 16, or both substrates 12 and 16.

The delivery system 30 may include lenses or other optics, mirrors or reflecting elements, and may also include a single core fiber to direct the laser beam 32. In the embodiment shown in FIG. 2, the delivery system 30 includes a lens 38, reflectors (mirrors) 40, 42, 44, a first coupling section 46, and a second coupling section 48. The reflectors 40, 42, 44 can partially reflect and partially transmit energy waves as appropriate, as is known in the art, so as to allow the energy waves to pass to various devices connected to the delivery system 30.

A beam from laser 31 is reflected by reflector 40 so as to travel through lens 38 and emerge as laser beam 32 that is directed toward display device 10. The laser beam 32 may be directed by a single core fiber disposed between the lens 38 and the display device 10.

Sealing with the Wall Thickness Within the Depth of Focus of the Laser Beam

In one embodiment, the lens 38 focuses the laser beam 32 from laser 31 so that the thickness 1 of the wall 14 is disposed within the depth of focus 34 of laser beam 32. The depth of focus 34 is the distance over which the focused laser beam 32 has substantially the same intensity, as described below. Generating a laser beam 32 so that its beam waist 37 is at or near the focal point increases the depth of focus 34 thereby providing higher tolerances for alignment and vibration leading to a more uniform seal. The beam waist 37 is the portion of the laser beam having a minimum width.

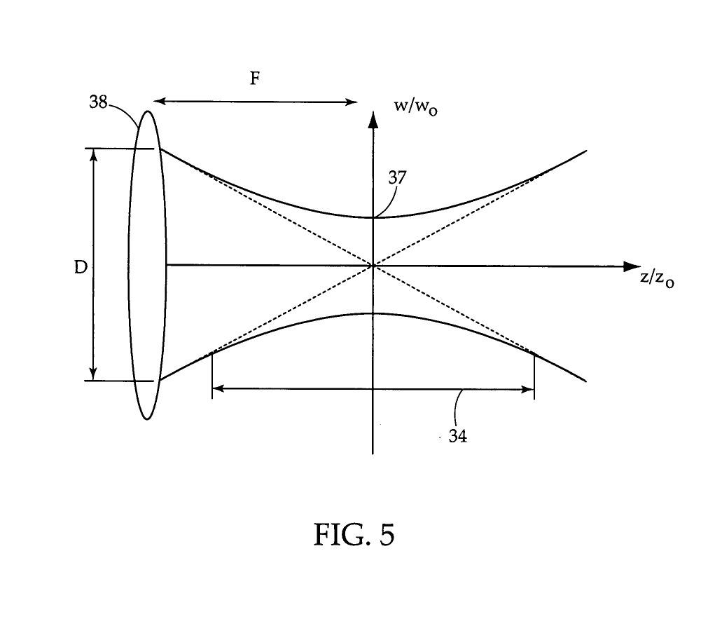

FIG. 5 illustrates the parabolic variation of the laser beam width with distance for a Gaussian beam, and a definition of Depth of Focus (DOF) 34.

Specifically, the relationship between beam width and distance is as follows:

$${( \frac{w}{{w}_{o}} )}^{2} = 1 + {( \frac{z}{{z}_{o}} )}^{2}$$

wherein:
w is beam width;
wₒ is beam width at the focal point;
z is distance from the focal point of lens; and
zₒ is the transition point between the near-field of the lens 38 and the far field of the lens 38.

Further, the DOF is defined as:

$$DOF = ( \frac{8 λ}{π} ) ( \frac{F}{D} ) ,$$

wherein:
F is focal length of the lens 38;
D is the diameter of the laser beam on the lens 38; and
λ is the wavelength of the laser.

In the far field, the beam width varies linearly with the distance from the focal point. On the other hand, in the near field, the beam width varies parabolicly with the distance from the focal point and has a minimum, i.e., a beam waist 37, at or near the focal point.

Around this focal point, within the depth of focus DOF 34, the beam width 36 does not experience great changes. As the beam is defocused away from the focal point F the beam width starts to change very rapidly requiring exact positioning in order to achieve a desired beam width value.

Therefore, producing sealed portion 6 in the wall 14 by placing the wall thickness 1 within the depth of focus 34, regardless of the shape of the footprint 35 of the laser beam 32, is advantageous because such operation is more insensitive to mechanical misalignments and vibrations, i.e., to changing distances between the delivery system 30 and the display device 10. However, operation within the depth of focus is less flexible in the sense that the beam width 36 will be fixed based on the lens arrangement used. Nonetheless, different beam widths 36 may be produced by changing the lens 38 and/or the diameter of the laser beam on the lens 38.

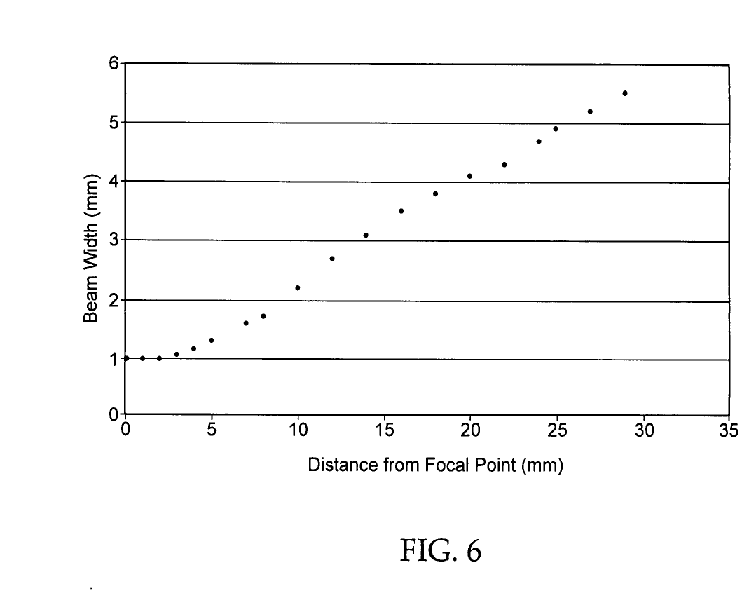

For example, for one lens system according to this embodiment, the beam width was plotted against the distance from the focal point. See FIG. 6. The beam was a flat-top beam having a waist of 1 mm. As shown in this figure, the beam width remains about 1 mm as the distance from the focal point ranges from 0 to about 3 mm. That is, the DOF 34 is around 6 mm. Because the thickness 1 of the wall 14 is on the order of up to hundreds of microns, a DOF 34 of 6 mm allows for a significant amount of variation in distance between the delivery system 30 and the display device 10, while maintaining the thickness 1 of the wall 14 within the DOF 34 of the laser beam 32 so as to produce a uniform seal.

Additionally, operating within the DOF 34 of the laser beam 32 offers another advantage. Specifically, an imaging device and/or thermal monitoring device can be implemented through the same delivery system 30 as used for the laser 31, thus improving the capability of the sealing process control feedback, reducing time for development of the optimal regime for sealing conditions. The imaging system and thermal monitoring systems can be used independently of one another, in conjunction with one another, or not at all.

As shown in FIG. 2, the delivery system 30 may include a first coupling section 46 to which an imaging device 50 is connected. The imaging device 50 may be a charge couple device (CCD), a complementary metal oxide semiconductor (CMOS) device, or a junction field effect transistor (JFET) device, for example. When the thickness 1 of the wall 14 is disposed within the DOF 34 of the laser beam 32 as propagated through lens 38, an image of the display device 10 may be captured by imaging device 50, via reflector 42 and lens 38.

As also shown in FIG. 2, the delivery system 30 may include a second coupling section 48 to which a thermal monitoring device 60 is connected. The thermal monitoring device 60 may be a pyrometer, a bolometer, or a thermal camera, for example. When the thickness 1 of the wall 14 is disposed within the depth of focus 34, it is a simple matter to capture thermal information through the lens 38 via reflector 44.

Laser Beam Width Relative to Wall Width

In another embodiment, the laser beam width 36 may be sized by the delivery system 30 so as to eliminate the need for a mask disposed adjacent to the wall 14. Elimination of a laser mask may reduce cost and improve efficiency of laser sealing.

A mask can be eliminated by choosing an appropriate laser beam width 36 relative to the width 2 of the wall 14 to be sealed. More specifically, the laser beam width 36 is chosen so as to be less than or equal to the width 2 of the wall 14. In this case, not 100% of the wall width will be sealed. However, by dispensing frit to form a wall 14 that is as wide as, or wider than, the width 36 of the laser beam 32, the width 3 of the sealed portion 6 itself can be maintained the same size as that obtained by having a wall width 2 sized to the 2ω diameter of a conventionally masked laser beam. In other words, the excess wall width 2 itself acts as a mask. Further, because mechanical strength and hermeticity are determined by seal width 3, the integrity of the seal 6 remains the same as that for a conventionally made seal. Accordingly, in terms of hermeticity and mechanical strength, the excess wall width does not make any noticeable impact.

In a display device 10, the space available for sealing is typically larger than the width of the frit typically dispensed. For example, for a 2″ device, a sealing space of 1.2-1.4 mm is typically available, yet the width of frit typically dispensed is 0.7 mm. This means that frit can be dispensed to form a wall 14 that is wider than that conventionally dispensed by utilizing more of the space available for sealing. Then, if the laser beam width 36 is chosen to be less than or equal to the width 2 of the wall 14, no laser mask will be needed.

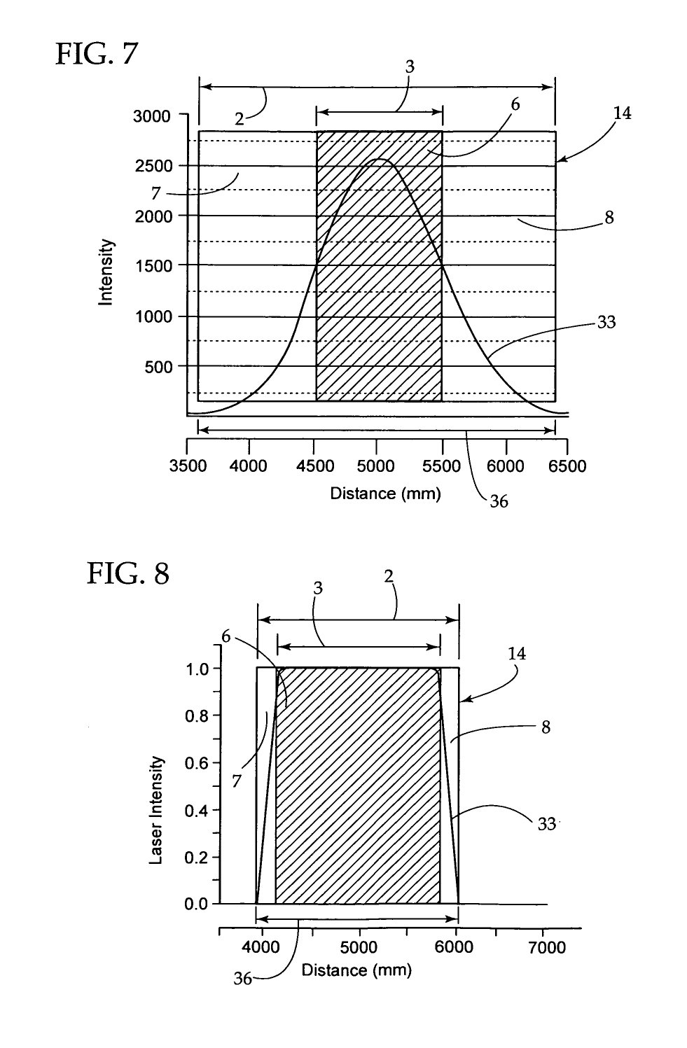

For example, as shown in FIG. 7, a Gaussian beam was chosen to have a width 36 substantially the same as the 2.8 mm dispensed frit width (corresponding to the width 2 of the wall 14). In FIG. 7, it is seen from the laser beam intensity profile 33 that the laser beam has a width 36 substantially equal to the width 2 of the wall 14. As noted above, the width 36 of the laser beam 32 is the width of the laser beam 32 at the point wherein the intensity drops to less than about 2-3% of its peak value. The laser beam width includes an intensity profile 33 having a maximum intensity portion, i.e., that portion of laser beam profile 33 within the cross-hatched area of FIG. 7, sufficient to form a sealed portion 6 in the wall 14. Also, the laser beam width includes lesser intensity portions, i.e., those portions of laser beam profile 33 outside the cross-hatched area of FIG. 7, that do not form a sealed portion 6 in the wall 14. Accordingly, the width 3 of the sealed portion 6 produced by the laser beam 32 is less than the width 36 of the laser beam 32, and is less than the width 2 of the wall 14. Unsealed portions 7 and 8 are disposed on either side of the sealed portion 6.

After heating with the Gaussian beam, the width 3 of the sealed portion 6 was about 1 mm. Thus, the sealed portion 6 has a width 3 of about 35.7% of the width 2 of the wall 14. The unsealed portions 7, 8 of the wall 14 thus act as a mask to shield the OLED element 18 and electrodes 20 of the display device 10 from damage by the laser beam 32. Because the wall 14 is sintered prior to heating it with the laser beam 32, there is no loose frit remaining in the display device 10, even though the entire width of the wall 14 does not form sealed portion 6. The 1 mm wide seal width 3 is similar to that of conventional seals and, thus maintains the same hermeticity and mechanical strength as conventionally sealed display devices.

By using a flat-top beam, as described above, a higher seal ratio can be obtained than with a Gaussian beam. Thus, a similarly sized wall width 2 will produce a larger seal width 3. See, for example FIG. 8, wherein a dispensed frit width of 2.2 mm (corresponding to the width 2 of the wall 14) resulted in a seal width 3 of 1.6-1.7 mm when using a flat-top beam of generally the same width 36 as the width 2 of the wall 14. For example, in FIG. 8, it is seen from the laser beam profile 33 that width 36 is substantially equal to the width 2 of the wall 14. As noted above, the width 36 of the laser beam 32 is the width of the laser beam 32 at the point wherein the intensity drops to less than about 2-3% of its peak value. The laser beam width includes an intensity profile 33 having a maximum intensity portion, i.e., that portion of laser beam profile 33 within the cross-hatched area of FIG. 8, sufficient to form a sealed portion 6 in the wall 14. Also, the laser beam width includes lesser intensity portions, i.e., those portions of laser beam profile 33 outside the cross-hatched area of FIG. 8, that do not form a sealed portion 6 in the wall 14. Accordingly, the width 3 of the sealed portion 6 produced by the laser beam 32 is less than the width 36 of the laser beam 32, and is less than the width 2 of the wall 14. Unsealed portions 7 and 8 are disposed on either side of the sealed portion 6.

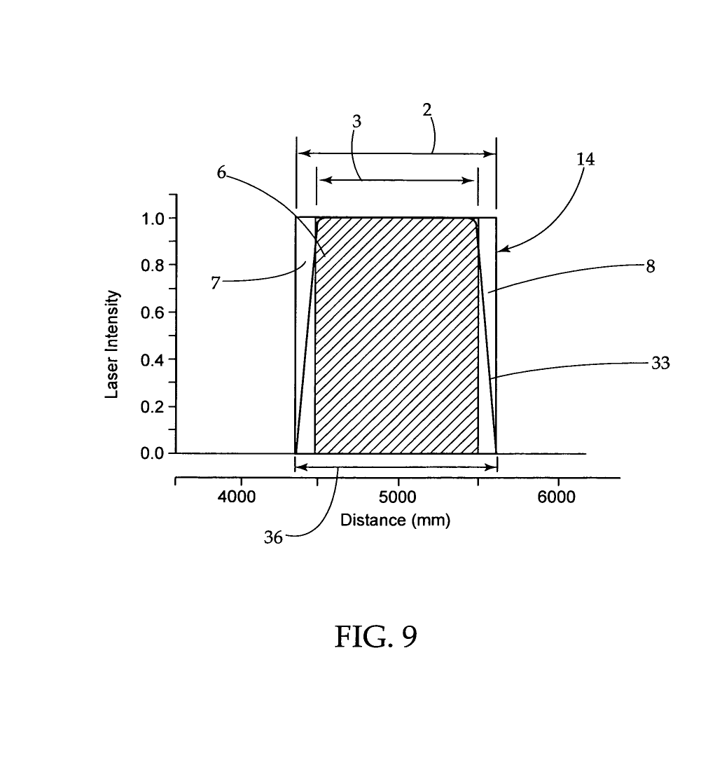

Similarly, with a flat-top beam frit can be dispensed into a smaller wall width 2 than for a Gaussian beam and yet the same seal width 3 can obtained. As shown in FIG. 9, when using a flat-top beam, a dispensed frit width of 1.3 mm (corresponding to the width 2 of the wall 14) resulted in the same 1 mm seal width 3 as for the Gaussian beam used on a dispensed frit width of 2.8 mm (as shown in FIG. 7). In FIG. 9, it is seen from the laser beam profile 33 that the laser beam width 36 is substantially equal to the width 2 of the wall 14. As noted above, the width 36 of the laser beam 32 is the width of the laser beam 32 at the point wherein the intensity drops to less than about 2-3% of its peak value. The laser beam width includes an intensity profile 33 having a maximum intensity portion, i.e., that portion of laser beam profile 33 within the cross-hatched area of FIG. 9, sufficient to form a sealed portion 6 in the wall 14. Also, the laser beam width includes lesser intensity portions, i.e., those portions of laser beam profile 33 outside the cross-hatched area of FIG. 9, that do not form a sealed portion 6 in the wall 14. Accordingly, the width 3 of the sealed portion 6 produced by the laser beam 32 is less than the width 36 of the laser beam 32, and is less than the width 2 of the wall 14. Unsealed portions 7 and 8 are disposed on either side of the sealed portion 6.

With each of the FIG. 8 and FIG. 9 arrangements, the seal width 3 was about 77% of the width of the dispensed frit (corresponding to the width 2 of the wall 14). A flat-top beam can be generated using all-refractive optics lens system based on IBM patented technology and offered by Newport Corporation, of Irvine, Calif. Accordingly, use of a flat-top beam allows greater design freedoms in that either a higher percentage seal (and thus stronger seal) may be obtained in the same space, or that a lower footprint wall (i.e., having a smaller width 2) may be used to obtain the same seal strength (as corresponds to the width 3 of the seal 6), as obtained with a Gaussian beam.

From the above examples, it is seen that a seal width 3 of from about 35.7% to about 77.3% of the width 2 of the wall 14 (for example 36, 38, 40, 42, 44, 46, 48, 50, 52, 54, 56, 58, 60, 62, 64, 66, 68, 70, 72, 74, 76 and 77%) can maintain a successful hermetic seal. Preferably, the seal width 3 is from about 50% to about 75% of the width 2 of the wall 14, for example 52, 54, 56, 58, 60, 62, 64, 66, 68, 70, 72, and 74%.

Any of the beam shapes in this disclosure may be used without a mask in the manner described above, i.e., wherein the width 2 of the wall 14 is equal to or larger than the width 36 of the laser beam 32. It is preferable to have the width 2 of the wall 14 sized relative to the footprint 35 of the laser beam 32 (including beam width 36) so that when the laser beam 32 traverses a corner or a curved portion of the wall 14, the laser beam footprint 35 remains within the edges 4, 5 of the wall 14, i.e., so that the laser beam 32 does not cause damage to portions of the display device 10 that are near the wall 14, for example, electrodes 20 or OLED element(s) 18. When using a laser beam width 36 as described above, the sealed portion 6 of the wall 14 will generally be located such that there are unsealed portions 7, 8 on either side of the sealed portion 6. See, for example, FIGS. 1 and 3.

Laser Beam Intensity Profile

Operating within the depth of focus 34 produces a hermetic seal in wall 14 that is just as strong as one produced by a defocused laser beam. Further, by selecting an appropriate laser beam intensity profile, a reduction in power may also be achieved while still maintaining the same seal strength.

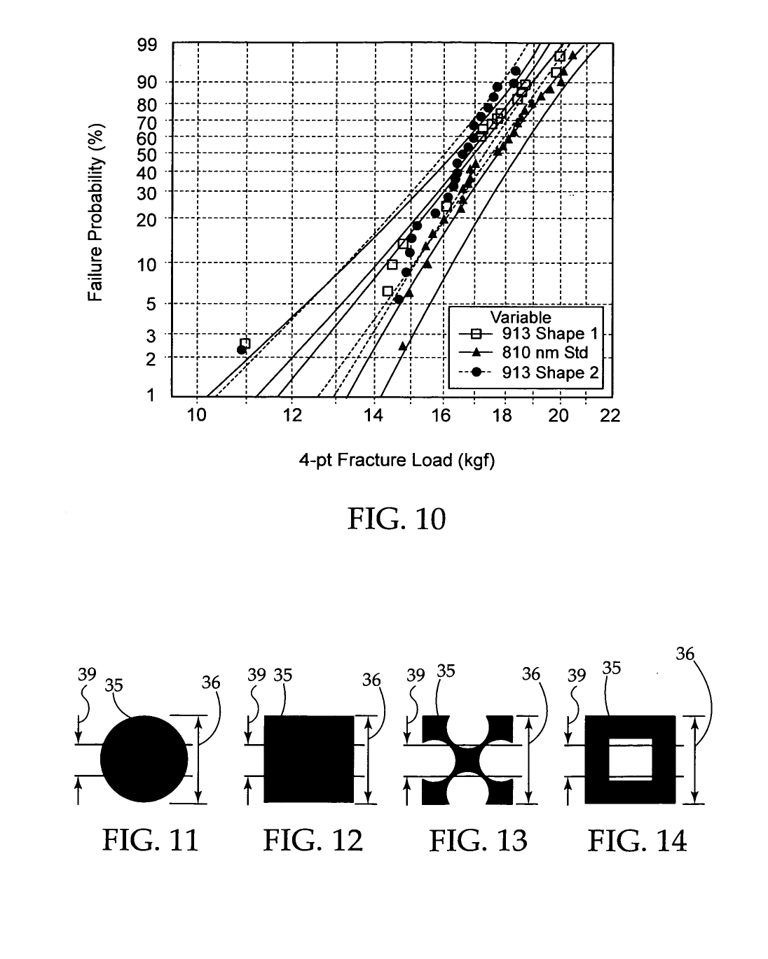

FIG. 10 shows data regarding probability of failure based on load testing dozens of samples sealed. Generally, the samples were prepared according to the above-described preparation process, and then sealed with different laser configurations. Specifically, frit was deposited to form a wall 14 on first substrate 12, subjected to sintering, and then disposed on second substrate 16 so that the wall 14 was disposed between the substrates. The walls 14 of different samples were then heated with the different laser configurations to form a hermetic seal between the substrates 12, 16. The resulting glass packages were subjected to a four-point load to determine probability of failure at various loading conditions.

The samples in the graph of FIG. 10 were sealed using either a Gaussian beam or a flat-top beam as described below, and with scaling of the beam width 36 relative to the wall width 2. Specifically, the width of the Gaussian beam was sized to 1.8 times the frit width, and the width of the flat-top beam was 1.65 times the frit width. Here a frit width of 0.7 mm was deposited to form a wall 14 having a corresponding width 2.

The different laser configurations were as follows.

Data points shown by triangles are for devices sealed with a standard defocused Gaussian beam made with a laser at 810 nm and 30 W. Data points shown by squares are for devices sealed with a defocused Gaussian beam made with a laser at 913 nm and 28 W. Data points shown by circles are for devices sealed with a focused flat-top beam made with a laser at 913 nm and 25 W. The laser was not a perfect flat-top beam because it still had some tails on the optical field near the edges.

As can be seen from the distribution of data points in FIG. 10, the samples sealed with the defocused Gaussian beam of 913 nm and 28 W (square data points) had a very similar probability of failure distribution as those made with the defocused Gaussian beam operating at 810 nm and 30 W (triangle data points). Each distribution experienced a significant rise in the probability of failure at a load of between 16 and 17 Kgf; note the almost vertical increase in failure probability over this range of force increase. Accordingly, the change from 810 nm to 913 nm, and resulting reduction in power, did not affect the seal strength.

Similarly, the samples sealed with the focused flat-top beam of 913 nm and 25 W (circle data points) had a very similar probability of failure distribution as those made with the defocused Gaussian beam operating at 913 nm and 28 W. Again, each distribution experienced a significant rise in the probability of failure at a load of between 16 and 17 Kgf; note the almost vertical increase in failure probability over this range of force increase. Accordingly, the samples sealed with the focused flat-top beam, using less power, did not affect the seal strength relative to the defocused beams of higher power.

Specifically, the 913 nm defocused Gaussian beam was sealed at 28 W while the flat top beam was sealed at 25 W, resulting in a reduction of 11% in power for the flat top beam; and a reduction of 17% in power for the flat top beam as compared to the 810 nm defocused Gaussian beam at 30 W. These two sets of samples sealed with different beam intensity profiles and power were tested for mechanical failure and, as noted above, in practice they presented the same probability of failure. This confirms that despite the power reduction found due to the laser beam characteristics, i.e., focused flat-top beam versus defocused Gaussian beam, the finished sealed sample had very similar mechanical properties. Accordingly, it is advantageous to use a focused flat-top beam. That is, there is likely to be less damage to the device elements and to the wall 14 itself due to the lower power. Overall, beneficially, less energy is deposited in the process.

The reduction in power from use of the flat-top beam can significantly benefit the sealing process and produce less damage for the device elements and the display devices 10 themselves. The reduction in power is based on a more uniform distribution of the power density across the wall 14.

If a less uniform laser beam intensity profile is used in order to achieve a maximum seal width, the central part of the wall 14 will be overheated as seen in a seal image as so called “laser track”, because the intensity near the center of the laser beam footprint 35 is greater than the intensity at the edges of the laser beam footprint 35. In addition to using a flat-top beam, in order to provide a more uniform profile, because the laser beam 32 moves, one also needs to consider that different locations of the wall 14 away from the center and towards its edges 4, 5 would have a different time of exposure. For this reason, the laser beam footprint 35 on the wall 14 instead of being circular may be closer to square shape, or one wherein the area near the center-portion 39 of the footprint 35 is less than the area on either side of the center-portion 39. The center-portion 39 of the footprint 35 spans about one third of the width 36 of the footprint 35, leaving areas on either side that each also span about one third of the width 36 of the footprint 35. See FIGS. 11-14, wherein FIG. 11 shows a circular footprint 35, FIG. 12 shows a square footprint 35 (area of the center-portion 39 of the footprint 35 is less than the area on either side of the center-portion 39), FIG. 13 shows a cross-shaped footprint 35, and FIG. 14 shows a square-in-square footprint 35. In FIGS. 13 and 14, the footprint 35 has an area of the center-portion 39 that is less than the area on either side of the center-portion 39. In the case of FIGS. 13 and 14, the exposure and power intensity applied to the wall 14 at different distances in the x-axis direction from the center of the wall 14 would be the same because the greater area on either side of the center-portion 39 of the footprint 35 compensates for the reduced intensity in that same area. Similarly, the reduced area of the center-portion 39 of the laser beam footprint 35 reduces the energy applied to the wall 14 by the portion of the laser beam having the greatest intensity. It is expected that a more flat laser beam intensity profile 33 used with the footprints 35 of FIGS. 12-14 would require less power for sealing to achieve a maximum seal width. However, in addition to the laser beam footprints 35 of FIGS. 12-14, circular footprints 35 (See FIG. 11) are also possible, as described later.

The laser beam footprints 35 may be selected so that they produce a uniform temperature distribution (heating profile) across the wall 14, as the laser beam 32 follows the path of the wall 14.

As shown in FIG. 4, the width of the wall 2 extends parallel to the x axis, and the laser beam footprint 35 translates in the direction of the y axis, with its width 36 extending substantially parallel to the x axis. In FIG. 4, the coordinate axis is shown for simplification of explanation only.

The equation showing the heating profile across the wall 14 is as follows:

T(x)=∫(I(x,y)*L(y)/v)dy,

where x is distance from center line of the frit, T(x) is temperature as function of x, I(x, y) is the distribution of the laser beam 32 intensity, which should be symmetrical relative to x and y, L(y) is the cross-section of the beam width at location x, and v is linear velocity of the beam translation. This equation neglects diffusion of heat in the x, y plane due to low heat diffusivity of the material from which the wall 14 is made. If heat diffusion takes place in the x, y plane, corresponding adjustments of the beam shape may be needed to make the resulting T(x) uniform as a function of x.

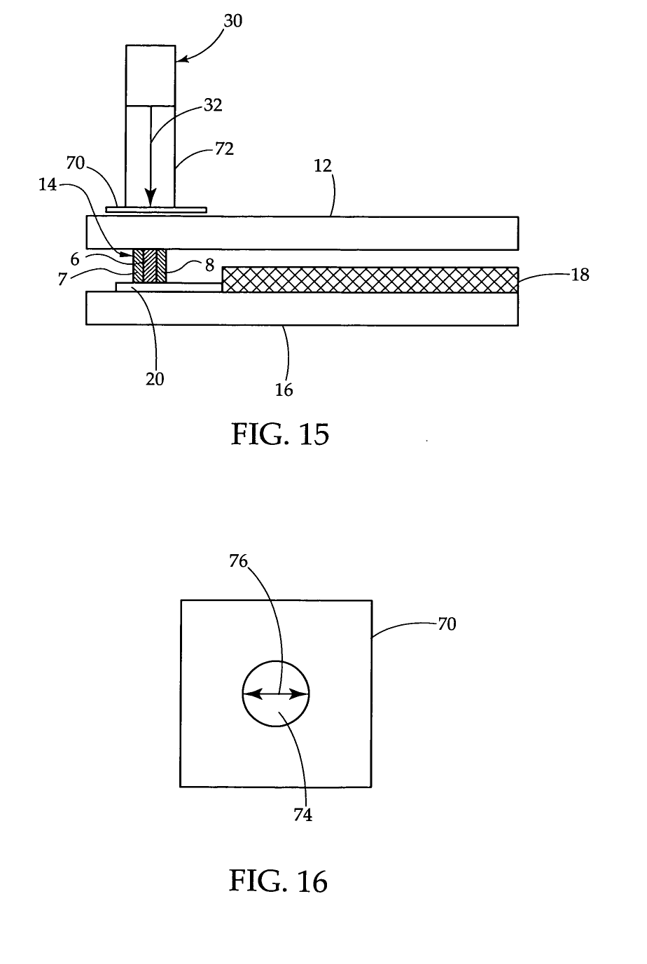

The laser footprints 35 of FIGS. 11-14 can be produced with an aperture, similar to that disclosed below in connection with FIGS. 15 and 16, or with diffractive optics, as is known in the art. By producing the shapes in these manners, the laser beam 32 can be delivered through a solid core and, therefore, avoid hot spots, or spikes in its profile, as when a focused beam is delivered through a fiber bundle. Diffractive optics that can be used to produce the footprints 35 shown in FIGS. 9-14 are available from RPC Photonics, of Rochester, N.Y. By producing the shapes with diffractive optics, or apertures, the delivery system 30 can still operate so that the thickness 1 of the wall 14 is located within the depth of focus 34 of the laser beam 32. These laser beam footprints 35 may be used in conjunction with other features and embodiments as disclosed herein.

Shaping the Laser Beam with an Aperture

In this embodiment, shaping the laser beam with an aperture allows the use of a Gaussian beam with reduced power to successfully provide a hermetic seal. FIGS. 15 and 16 show a manner of shaping the laser beam 32 with the use of an aperture 74 in a beam-shaping plate 70. Here, beam-shaping plate 70 is coupled to the delivery system 30 via a coupling member 72, so that the beam-shaping plate 70 moves along with the laser beam 32 as the laser beam 32 follows the path of the wall 14. The coupling member 72 may be a hollow tube or other mechanical coupling structure. The inside of the coupling member 72 may have a light-absorbing surface to minimize light scattering. The aperture 74 shapes the laser beam 32 as the beam passes therethrough. The aperture 74 has a width 76 that is sized to be less than, or equal to the width 2 of the wall 14. During a sealing operation, the beam-shaping plate 70 is placed in close contact with the first substrate 12, and the laser beam 32 is made to follow along the path of the wall 14. Laser energy passing through the aperture 74 heats the wall 14 and forms a sealed portion 6 in the wall 14. In contrast to conventional masks, the beam-shaping plate 70 does not cover the entire first substrate 12, but instead operates to shape the laser beam footprint 35.

In one example, a wall 14 having a width of 1.2 mm was sealed with a Gaussian beam of 60 W before passing through the beam-shaping plate 70 and aperture 74. The aperture width 76 was set at 1.1 mm, and allowed a power of about 20 W to leak through to the wall 14. The laser beam 32 was moved at 10 mm/s relative to the wall 14, and the resulting seal width 3 was 1.1 mm.

The beam-shaping plate 70 may be used in connection with any of the other laser configurations described herein, and may be disposed within the depth of focus 34 of the laser beam 32. Alternatively, the beam-shaping plate 70 may be used with other laser systems not disclosed herein. Additionally, the aperture 74 may be configured so as to have any shape, for example shapes matching the laser beam footprints 35 shown in FIGS. 8-11, and still allow the laser apparatus 30 to operate so that the wall 14 lies within the depth of focus 34 of the laser beam 32.

It should be emphasized that the above-described embodiments of the present invention, particularly any “preferred” embodiments, are merely possible examples of implementations, merely set forth for a clear understanding of principles of the invention. Many variations and modifications may be made to the above-described embodiments of the invention without departing substantially from the spirit and principles of the invention. All such modifications and variations are intended to be included herein within the scope of this disclosure and the present invention and protected by the following claims.

What is claimed is:

1. A device comprising:
a first substrate;
a second substrate; and
a wall coupling the first substrate to the second substrate, the wall comprising a width, a thickness, a sealed portion, and unsealed portions located on opposite sides of the sealed portion, wherein the wall contains glass, and
wherein a width of the sealed portion comprises from about 35% to about 77.3% of the width of the wall.

2. The device according to claim 1, wherein the width of the sealed portion comprises from about 50% to about 75% of the width of the wall.

3. The device according to claim 1, wherein the sealed portion is disposed in the wall so that the unsealed portions are substantially equal in width.

4. The device according to claim 1 further comprising:
at least one organic element disposed between the first substrate and the second substrate,
wherein the sealed portion forms a hermetic seal between the first substrate and the second substrate so as to protect the at least one organic element located between the first substrate and the second substrate.

5. A method of sealing two substrates coupled by a wall including a thickness, the method of sealing comprising the steps of:
directing a laser beam toward the wall, the laser beam comprising a depth of focus, wherein the laser beam is positioned relative to the wall so that the wall thickness lies within the depth of focus of the laser beam.

6. The method of claim 5, wherein the laser beam further comprises a beam width, wherein the wall further comprises a width, and the beam width is less than or equal to the width of the wall.

7. The method of claim 6, wherein the laser beam further comprises a beam width having an intensity profile, wherein the wall further comprises a width, and the intensity profile produces in the wall a sealed portion having a width, wherein the width of the sealed portion comprises from about 35% to about 77.3% of the width of the wall.

8. The method of claim 5, wherein the laser beam further comprises a beam width, wherein the wall further comprises a width, wherein the beam width is larger than the width of the wall, and the method further comprises disposing a beam-shaping plate having an aperture therein so that the laser beam is aligned to pass through the aperture prior to reaching the wall, wherein the aperture has a width that is less than or equal to the width of the wall.

9. The method of claim 8, further comprising traversing the laser beam relative to the wall, and traversing the beam-shaping plate along with the laser beam so as to maintain alignment between the laser beam and the aperture.

10. The method of claim 8, wherein the beam-shaping plate is disposed within the depth of focus of the laser beam.

11. The method of claim 5, wherein the laser beam comprises a flat-top laser beam.

12. The method of claim 5, wherein the laser beam further comprises a footprint having a center-portion, wherein an area of the center-portion is less than an area on either side of the center-portion.

13. The method of claim 5, wherein the step of directing the laser beam further comprises directing the laser beam through a delivery system, wherein the delivery system comprises a lens for focusing the laser beam, and the method further comprises at least one of:
measuring temperature of the wall with a thermal monitoring device via the lens; and
obtaining a visual image of the wall with an imaging device via the lens.

14. A method of sealing a two substrates coupled by a wall including a width, the method of sealing comprising the steps of:
directing a laser beam toward the wall, the laser beam comprising a beam width, the beam width including an intensity profile, the intensity profile comprising a maximum intensity portion sufficient to form a sealed portion in the wall and lesser intensity portions that do not form a sealed portion in the wall, wherein the laser beam is positioned relative to the wall so that the beam width is less than or equal to the wall width.

15. The method of claim 14, wherein the maximum intensity portion of the intensity profile produces in the wall a sealed portion having a width, wherein the width of the sealed portion comprises from about 35% to about 77.3% of the width of the wall.

16. The method of claim 14, wherein the laser beam comprises a flat-top laser beam.

17. The method of claim 14, wherein the laser beam further comprises a footprint having a center-portion, wherein an area of the center-portion is less than an area on either side of the center-portion.

18. The method of claim 14, wherein the wall further comprises a thickness, wherein the laser beam further comprises a depth of focus, and the wall thickness lies within the depth of focus of the laser beam.

19. The method of claim 18, wherein the step of directing the laser beam further comprises directing the laser beam through a delivery system, wherein the delivery system comprises a lens for focusing the laser beam, and the method further comprises at least one of:
measuring temperature of the wall with a thermal monitoring device via the lens; and
obtaining a visual image of the wall with an imaging device via the lens.
